(19) United States
(12) Patent Application Publication
(10) Pub. No.: US 2013/0002391 A1
(43) Pub. Date: Jan. 3, 2013

(54) MULTILAYERED POWER INDUCTOR AND METHOD FOR PREPARING THE SAME

(75) Inventors: Ic Seob KIM, Gyeonggi-do (KR); Soo Hwan SON, Seoul (KR); Sung Yong AN, Gyeonggi-do (KR); Jin Woo HAHN, Gyeonggi-do (KR); Byeong Cheol MOON, Seoul (KR)

(73) Assignee: SAMSUNG Electro-Mechanics Co., Ltd.

(21) Appl. No.: 13/534,707

(22) Filed: Jun. 27, 2012

(30) Foreign Application Priority Data
Jun. 28, 2011 (KR) 10-2011-0062941

(51) Int. Cl. H01F 27/24; H01F 41/32

(52) U.S. Cl. 336/233; 427/58

(57) ABSTRACT

Disclosed herein are a multilayered power inductor including a magnetic layer having a structure in which a metal magnetic powder is distributed on a glass substrate, a composition for the magnetic layer, and a method for preparing a multilayered power inductor. According to an exemplary embodiment of the present invention, the multilayered power inductor including a magnetic layer obtained by mixing the metal magnetic powder having high Ms with the glass substrate has excellent bias characteristics having small variations in capacity even when high current is applied. In addition, the exemplary embodiment of the present invention can use Cu as an inner electrode, instead of an expensive precious metal Ag.

### CROSS REFERENCE(S) TO RELATED APPLICATIONS

This application claims the benefit under 35 U.S.C. Section 119 of Korean Patent Application Serial No. 10-2011-0062941, entitled “Multilayered Power Inductor and Method for Preparing the Same” filed on Jun. 28, 2011, which is hereby incorporated by reference in its entirety into this application.

### BACKGROUND OF THE INVENTION

1. Technical Field

The present invention relates to a multilayered power inductor including a magnetic layer having a new structure, a composition for the magnetic layer, and a method for preparing a multilayered power inductor.

2. Description of the Related Art

A saturation magnetization (Ms) value of a magnetic powder is a physical property that affects change characteristics in inductance (capacity) at the time of applying bias, in products such as a power inductor, or the like. The higher the saturation magnetization value of a material, the better the variations in bias becomes at the time of applying current. The improvement of the variations in bias means that the variations in bias are reduced, which is a characteristic required for a power inductor element. However, each component of the current magnetic material has a limited Ms and the increase in Ms of the power inductor element is also limited accordingly.

FIG. 1 shows a structure of a multilayered chip power inductor according to the related art. Referring to FIG. 1, the multilayered chip power inductor is prepared by distributing a ferrite powder made of NiZnCuFe₂O₄ to a binder base, printing an inner electrode, i.e., a conductor pattern 20 on a magnetic body 10 molded in a film type, and stacking and firing the conductor pattern. In addition, in order to improve bias, a chip has been prepared based on an idea of improving the variations in bias by inserting a non-magnetic material 30 without magnetic characteristics between electrode layers so as to block a magnetic field generated at the time of applying current. However, the above-mentioned structure has a negative effect of reduction inductance capacity of the inductor element against the bias blocking effect. Therefore, the related art may not satisfy both of the inductance and the bias characteristics.

The ferrite powder is composed into a spinel phase having a NiZnCuFe₂O₄ structure by mixing and calcincating NiO, CuO, ZnO, and Fe₂O₃ at a necessary ratio so as to have magnetic characteristics.

Whether unpaired electrons revealing the magnetic characteristics of the material in electron configuration of atoms or ions are present is determined by measuring a magnetic moment of the material (particles). If any particles are attracted to an external magnetic field, the particles have at least one unpaired electron. The material having the above-mentioned characteristics is referred to as a paramagnetic material. Meanwhile, all the materials including only the paired electrons are repelled to the magnetic field. The material having the above-mentioned characteristics is referred to as a diamagnetic material. In the material including both of the paired electrons and the unpaired electrons, the diamagnetic magnitude is much smaller than the paramagnetic magnitude, such that the diamagnetic material may be disregarded. Therefore, the magnitude in magnetic moment is determined according to the number of unpaired electrons. When the number of unpaired electrons is set to be n, the approximate magnitude in magnetic moment may be represented as follows.

The relationship formula is referred to as a spin only formula, where a unit of the magnetic moment μ is Bohr magneton (BM).

The BM of metal ion for each raw material configuring the magnetic powder is as follows.

### Electron Configuration of Fe³⁺:

$$[ Ar ] 3 {d}^{5} 4 {S}^{0} \underline{} \underline{} \underline{} \underline{} \underline{} —$$

$$3 d 4 s$$

$$μ ( {Fe}^{3 +} ) = \sqrt{5 ( 5 + 2 ) =} 5.91 BM$$

### Electron Configuration of Zn²⁺:

$$[ Ar ] 3 {d}^{10} 4 {s}^{0} \underline{} \underline{} \underline{} \underline{} \underline{} —$$

$$3 d 4 s$$

$$μ ( {Zn}^{2 +} ) = \sqrt{0 ( 0 + 2 )} = 0 BM$$

### Electron Configuration of Cu²⁺:

$$[ Ar ] 3 {d}^{9} 4 {s}^{0} \underline{} \underline{} \underline{} \underline{} \underline{} —$$

$$3 d 4 s$$

$$μ ( {Cu}^{2 +} ) = \sqrt{1 ( 1 + 2 )} = 1.73 BM$$

### Electron Configuration of Ni²⁺:

$$[ Ar ] 3 {d}^{9} 4 {s}^{0} \underline{} \underline{} \underline{} \underline{} \underline{} —$$

$$3 d 4 s$$

$$μ ( {Ni}^{2 +} ) = \sqrt{2 ( 2 + 2 )} = 2.83 BM$$

Meanwhile, the saturation magnetization is about 70 emu/g to the maximum when being measured.

In this case, the Bohr magneton is OBM in the case of Zn, which affects the position movement of the coupling site of Fe ion in the spinel structure when composing the spinel phase. Therefore, some of Fe²⁺ ions are substituted into Zn ion sites to change the coupling site, which may reveal the magnetic characteristics and lower a calcination temperature and a firing temperature of the ferrite powder.

The spinel phase (AB₂O₄ structure) composed by the calcinations reaction from a starting raw material of the magnetic powder according to the related art is three such as NiFe₂O₄, CuFe₂O₄, and ZnFe₂O₄ and may control the saturation magnetization value according to the composition ratio thereof. However, since the Bohr magneton value of a raw material of each NiO, CuO, ZnO, and Fe₂O₃ is limited, it is difficult to increase the saturation magnetization value determined by the Bohr magneton of the material to 70 emu/g or more, which is an approximate saturation magnetization characteristic value of the material only by the design of the composition. Further, it is difficult to implement higher Ms so as to improve the bias.

Therefore, as the existing NiZnCuFe₂O₄ magnetic powder, it is difficult to improve the bias characteristics achieved by the design change in the inner conductor pattern and the insertion of the non-magnetic gap material layer and improve the variations in bias as the material characteristics.

Recently, as the method of implementing the higher Ms, a product having a body formed by mixing a magnetic metal powder with an organic material such as epoxy, or the like, and prepared by having inner electrodes wound therein similar to the wound inductor product has been released as a bias improvement product. However, the above product and the magnetic body are hardened by mixing the organic material with the magnetic metal powder, which may seriously deformed under conditions such as high temperature and high humidity and may be weak at a rigid portion. In addition, it is difficult to suggest a method for increasing the additional Ms while changing the mixing ratio of the organic material and the metal magnetic powder.

### SUMMARY OF THE INVENTION

An object of the present invention is to provide a multilayered power inductor including a magnetic layer having a new structure capable of improving bias.

Another object of the present invention is to provide a magnetic layer composition of a multilayered power inductor.

Another object of the present invention is to provide a method for preparing a multilayered power inductor.

According to an exemplary embodiment of the present invention, there is provided a multilayered power inductor including a magnetic layer having a structure in which a metal magnetic powder is distributed on a glass substrate.

The metal magnetic powder may be Fe or a Fe-alloy containing 80 wt % or more of Fe.

The magnetic layer may further include an insulating material.

The insulating material may be a non-magnetic material and a material allowing metal magnetic material particles not to be coupled to each other through a firing process.

The metal magnetic powder may be coated with glass.

The metal magnetic powder may be sequentially coated with an insulating material and glass.

The multilayered power inductor may not include a separate non-magnetic gap layer, and the glass substrate may serve as a non-magnetic gap material for the metal magnetic powder.

The magnetic layer may be provided with an inner electrode.

The inner electrode may be one or more selected from a group consisting of Ag, Sn, Ni, Pt, Au, Cu, and an alloy thereof.

The inner electrode may be Cu.

According to an exemplary embodiment of the present invention, there is provided a composition for a magnetic layer for a multilayered power inductor in which a metal magnetic powder is distributed on a glass substrate.

The glass substrate: the metal magnetic powder may be mixed at a volume ratio of 10:90 to 90:10.

The glass substrate may use as main component SiO₂ of Ts 500 to 800° C.

According to an exemplary embodiment of the present invention, there is provided a method for preparing a multilayered power inductor, including: preparing a green sheet from a mixture of a glass substrate and a metal magnetic powder; printing and stacking an inner electrode on the green sheet; and sintering the green sheet.

The sintering may be performed in a reduction atmosphere or in a vacuum state.

### BRIEF DESCRIPTION OF THE DRAWINGS

FIG. 1 is a structure of an oxide ferrite magnetic layer in a power inductor according to the related art;

FIG. 2 is a magnetic layer cross section structure in a power inductor according to an exemplary embodiment of the present invention; and

FIG. 3 is a result of a saturation magnetization (Ms) graph of a sample according to Example 1 and a Comparative Example 1.

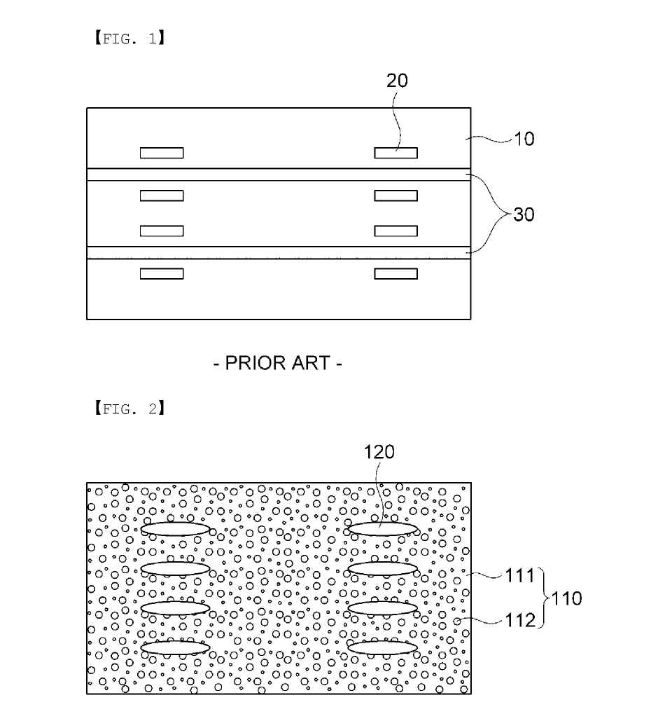

### DESCRIPTION OF THE PREFERRED EMBODIMENTS

Hereinafter, the present invention will be described in more detail.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

The present invention relates to a multilayered power inductor including a magnetic layer having a new structure, a composition for the magnetic layer, and a method for preparing a multilayered power inductor.

The multilayered power inductor according to the exemplary embodiment of the present invention includes a magnetic layer having a structure in which a metal magnetic powder is distributed on a glass substrate.

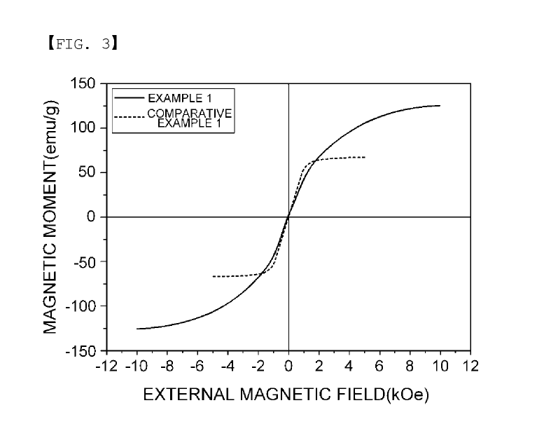

Next, FIG. 2 shows a structure of a magnetic layer 110 in the multilayered power inductor according to an exemplary embodiment of the present invention. Referring to FIG. 2, the structure of the magnetic layer 110 has a structure in which the metal magnetic powder 112 is distributed on the glass substrate 111.

As the metal magnetic powder used for the exemplary embodiment of the present invention, Fe or Fe-alloy containing 80 wt % or more of Fe may be used. An example of the Fe-alloy containing 80 wt % or more of Fe may include sendust (Fe—Al—Si), but is not limited thereto.

The Fe metal that is the metal magnetic powder used for the exemplary embodiment of the present invention has a saturation magnetization value of about 218 emu/g, which may have Ms about three times higher than the maximum saturation magnetization value of oxide ferrite. In addition, the Fe metal can be easily obtained from natural elements. Using the Fe metal as a material of the main magnetic layer can increase price competitiveness while greatly improving bias of the power inductor.

In addition, when a weak magnetic field is applied, a NiCuZn—Fe₂O₄ material early saturates the Ms, but in the present invention, the change in the inductance value due to the applied current indicates a behavior in which the magnetization is continuously progressed even in an area to which the high current is applied by mixing and sintering iron having high Ms or an alloy thereof with glass, thereby improving the DC-bias characteristics.

According to the exemplary embodiment of the present invention, the magnetic layer may additionally include an insulating material. That is, the metal magnetic powder may be distributed on the glass substrate together with the insulating material. The insulating material serves to prevent the contact between the metal magnetic powder and may remain or be removed in the sintering body after being sintered.

An example of the insulating material may include an organic based material or glass, or the like, that may indicate the insulating characteristics, but is not limited thereto.

In addition, according to an exemplary embodiment of the present invention, the metal magnetic powder may be coated with glass. That is, the metal magnetic powder is first coated with a glass and then, the metal magnetic powder coated with the glass may be distributed on the glass substrate. In this case, the metal magnetic powder may be preferred since the metal magnetic powder may be more uniformly distributed on the glass substrate.

In addition, according to the exemplary embodiment of the present invention, the metal magnetic powder may be sequentially coated with the insulating material and the glass. That is, the metal magnetic powder is primarily coated with the insulating material and secondarily coated with the glass. Thereafter, the metal magnetic powder sequentially coated with the insulating material and the glass may be distributed on the glass substrate. In this case, the metal magnetic powder is preferred since the metal magnetic powder may be distributed in a form of individual particles.

In the multilayered power inductor according to the exemplary embodiment of the present invention, the glass substrate serves as a non-magnetic gap material for the metal magnetic powder without including a separate non-magnetic gap layer.

That is, FIG. 2 shows a structure in which the metal magnetic powder 112 on the glass substrate 111 is fired and isolated. The metal powders 112 having magnetism are surrounded by the glass. The glass substrate 111 serves as the non-magnetic gap material for each metal powder 112.

Therefore, the glass substrate in the magnetic layer of the exemplary embodiment of the present invention can serve as the non-magnetic barrier rib blocking the magnetic field applied to the metal magnetic powders each of which is distributed and isolated, such that the glass substrate serves to improve the bias characteristics by functioning as the non-magnetic gap material of the power inductor chip.

In the power inductor according to the related art, the non-magnetic gap layer is added between the magnetic layers so as to improve the bias characteristics, but the exemplary embodiment of the present invention does not require the separate non-magnetic gap layer since the glass substrate serves as the non-magnetic gap material. Therefore, since the stacked number may be increased as compared with the power inductor including the non-magnetic gap layer, the exemplary embodiment of the present invention can increase the efficiency and since the non-magnetic gap layer is not included, the exemplary embodiment of the present invention can meet a demand for a small-sized power inductor.

Meanwhile, the magnetic layer 110 according to the exemplary embodiment of the present invention molds a green sheet in a film type having a predetermined thickness by mixing the metal magnetic powder 112 on the glass substrate 111 at a predetermined ratio and then, distributing the mixture to a binder by the same method as the existing chip forming method. The inner electrode 120 made of a conductor electrode material is formed on the molded green sheet.

The inner electrode 120 may be made of one or more selected from a group consisting of Ag, Sn, Ni, Pt, Au, Cu, and an alloy thereof. Among others, Cu may be the most preferably used.

In the exemplary embodiment of the present invention, when the magnetic powder in an oxide state according to the related art is used as the magnetic layer material, expensive Ag is used as the inner electrode material. In the exemplary embodiment of the present invention, Fe and an alloy thereof are used as the metal magnetic powder, such that the expensive inner electrode, that is, Ag may be replaced by an inexpensive electrode material such as Cu, or the like. Therefore, the power inductor can secure the competitive price and technology.

Meanwhile, the exemplary embodiment of the present invention may provide the composition for the magnetic layer of the multilayered power inductor. In detail, the composition for the magnetic layer according to the exemplary embodiment of the present invention may be prepared by distributing the metal magnetic powder to the glass substrate. In this case, the glass substrate: the metal magnetic powder may be mixed at a volume ratio of 10:90 to 90:10. When being out of the mixing ratio, it is highly likely to increase short occurrence due to the connectivity contact between the metal magnetic powders, the connectivity contact between the metal magnetic powder and the inner electrode, or the like, and it is not preferred to implement the inductance characteristics, or the like, due to the lack of the magnetic metal powder.

The glass substrate uses as main component SiO₂ having a softening temperature (Ts) of 500 to 800° C. If the glass powder may serves as a matrix effectively distributing the metal magnetic powder, all glass powders may be used.

In addition, the exemplary embodiment of the present invention may prepare the glass powder by adding the metal magnetic powder, that is, the Fe at the time of preparing the glass powder. In this case, the magnetic characteristics may be allocated to the glass itself by including the Fe component in the glass structure, such that the Ms may be further increased.

In addition, as the metal magnetic powder, Fe or Fe-alloy containing 80 wt % or more of Fe may be used as described in detail. An example of the Fe-alloy containing 80 wt % or more of Fe may include sendust (Fe—Al—Si), but is not limited thereto.

According to the exemplary embodiment of the present invention, the composition for the magnetic layer additionally includes the insulating material, such that the metal magnetic powder may be distributed on the glass substrate together with the insulating material. The insulating material may serve to distribute and isolate the metal magnetic powder similar to the glass substrate and may be removed by pyrolysis during the sintering. An example of the insulating material may include glass or organic material, but is not limited thereto.

In addition, according to an exemplary embodiment of the present invention, the metal magnetic powder may be coated with glass. That is, the metal magnetic powder is first coated with a glass and then, the metal magnetic powder coated with the glass may be distributed on the glass substrate. The glass coating the metal magnetic powder may use the same material as the glass used as the substrate, but is not limited thereto.

In addition, according to the exemplary embodiment of the present invention, the metal magnetic powder may be sequentially coated with the insulating material and the glass. That is, the metal magnetic powder is primarily coated with the insulating material and secondarily coated with the glass. Thereafter, the metal magnetic powder sequentially coated with the insulating material and the glass may be distributed on the glass substrate. The insulating material and the glass used for the coating of the metal magnetic powder may use the above-mentioned materials.

The exemplary embodiment of the present invention mixes the metal magnetic power with the glass powder configuring the composition for the magnetic layer and selectively mixes insulating material therewith at a predetermined ratio and then, mixes it with the binder, a solvent, and additives, thereby preparing the green sheet in the film type having a predetermined thickness.

The binder is used to give printability. For example, Ethyl cellulose, acrylic, polyvinyl butyral, polyvinyl alcohol, nitro cellulose, phenol, urethane, polyester, rosin, melamine, and urea resin may be used alone or as a mixture thereof. The contents thereof may be included at a level used for the composition for the magnetic layer, but is not particularly limited.

In addition, as the solvent, an alcoholic based solvent such as dihydro-terpineol, dihydro-terpinyl acetate, buthyl carbitol, buthyl carbitol acetate, texanol, mineral sprit, octanol, or the like; a ketone based solvent; a cellosolve based solvent; an ester based solvent; and an ether based solvent may be used alone or as a mixture thereof. The contents thereof may be included at a level used for the composition for the magnetic layer, but is not particularly limited.

Hereinafter, a method for preparing a multilayered power inductor according to an exemplary embodiment of the present invention including a magnetic layer having the above-mentioned characteristics will be described in detail.

First, a first process prepares the green sheet from the composition for the magnetic layer including a mixture of the glass substrate and the metal magnetic powder. The composition for the magnetic layer is already described in detail.

A second process prints the inner electrode of a conductor electrode material on the molded green sheet and stacks it.

The inner electrode may be made of one or more selected from a group consisting of Ag, Sn, Ni, Pt, Au, Cu, and an alloy thereof. Among others, Cu may be the most preferably used.

Then, the multilayered power inductor according to the exemplary embodiment of the present invention may be prepared by sintering the stacked sheet. In the exemplary embodiment of the present invention, it is important to perform a sintering under the reduction atmosphere or the vacuum condition in which the metal magnetic powder included in the magnetic layer is not oxidized.

When the sintering is performed under the condition in which the metal magnetic powder is not oxidized, the metal magnetic powders are isolated and distributed on the glass substrate in the magnetic layer. Therefore, when a magnetic field is applied, the glass substrates serve as the non-magnetic barrier rib (gap layer) blocking the magnetic field applied to the metal magnetic powders. Therefore, it is possible to improve the bias characteristics of the finally prepared power inductor.

At the same time, Cu may be substantially used as the inner electrode, instead of Ag according to the related art. The inner electrode used for the related art, that is, Ag does not cause a large problem under the condition in which there is oxygen at the time of sintering. However, when the Cu is used as the inner electrode and is sintered in the oxidation condition, the copper is oxidized to remove the conductivity, which may not be used as the inner electrode. Therefore, as the magnetic layer material according to the exemplary embodiment, the Fe-based metal magnetic powder is sintered under the condition in which there is no oxygen, such that the material of the inner electrode may be replaced by Cu, instead of a precious metal, that is, Ag.

Hereinafter, preferred examples of the present invention will be described in detail. The following examples describe the present invention by way of example only and the scope of the present invention is not construed as being limited to the following examples. In addition, the following examples are described using specific compounds, but in even when equivalents thereof are used, it is apparent to those skilled in the art that the same or like effects are shown.

### EXAMPLE 1

The composition for the magnetic layer was prepared by mixing the glass substrate (configured of SiO₂:B₂O₃:K=86:13:1 mol %, Ts 600° C.) to the Fe metal (Ms=218 emu/g) at a volume ratio of 60(glass):40(metal) and adding the binder and the solvent thereto. The molded sample was prepared by adding a predetermined amount of composition for the magnetic layer to the metal mold in a toroidal type and by uniaxially pressing it by hand press.

The sintering body in which the metal magnetic powder is isolated and distributed on the glass substrate by firing the core in a vacuum sintering furnace of 900° C. was obtained.

In addition, the sinterability was confirmed by sintering a copper powder as the inner electrode in the vacuum atmosphere when being sintered.

### COMPARATIVE EXAMPLE 1

The sintering body was obtained by the same method as the above Example 1 except that Comparative Example 1 adds, as the material for the magnetic layer about 0.2 mol % of one or more additive selected from a group consisting of Bi₂O₃, CoO, and TiO₂ for 100 mol % of NiZnCu—Fe₂O₄.

### EXPERIMENTAL EXAMPLE

### Measurement of Saturation Magnetization Value

The saturation magnetization value of the sintering body sample obtained according to Exemplary Embodiment 1 and Comparative Example 1 was measured and the measured results were shown in FIG. 3.

As the results of FIG. 3, when the NiCuZn—Fe₂O₄ material of Comparative Example 1 was used as the material for the magnetic layer, it could be appreciated that the Ms was early saturated in the state in which the weak magnetic field is applied.

However, when the material for the magnetic layer was used for the Fe metal magnetic powder distributed on the glass substrate as in Example 1 of the present invention, it was confirmed that the externally applied magnetic field is increased and thus, the behavior by which the magnetization is continuously progressed even in a strong magnetic field area is shown.

From these results, in the glass for the multilayered power inductor according to the exemplary embodiment of the present invention, the glass substrate serves as the non-magnetic gap layer that effectively isolates and distributes the metal magnetic powder without the metal magnetic powder mixing materials including the separate gap layer, there by improving the DC-bias characteristics.

In addition, as the result of sintering the copper powder as the inner electrode material in the reduction atmosphere, it could be confirmed that the sinterability was excellent. Therefore, since the exemplary embodiment of the present invention can substantially use the Cu as the inner electrode so as to replace the expensive precious metal, that is, Ag, it is possible to secure the price competitiveness that meets a demand of a market.

As set forth above, the exemplary embodiment of the present invention mixes and sinters iron having higher Ms or an alloy thereof with a glass substrate so that a sintering body indicates a behavior by which the magnetization thereof is continuously progressed even in a strong magnetic field area in which externally applied magnetic field is large, thereby improving the DC-bias characteristics.

In addition, the magnetic layer obtained by mixing the metal magnetic powder having the high Ms with the glass substrate can obtain the magnetic sintering body having the high saturation magnetization characteristics as the material for the power inductor In addition, the exemplary embodiment of the present invention can obtain the magnetic sintering body having the excellent bias characteristics with the small variations in capacity even at the time of applying high current.

Further, the metal powder can be isolated and distributed on the glass substrate by mixing the metal magnetic powder with the non-magnetic glass substrate powder and then, being sintered under the sintering conditions in which the metal magnetic powder is not oxidized. In this sintering structure, the glass substrate can serve as the non-magnetic barrier rib blocking the magnetic field applied to the metal magnetic powders each of which is distributed and isolated, such that the glass substrate serves to improve the bias characteristics by functioning as the non-magnetic gap material of the power inductor chip.

According to the exemplary embodiment of the present invention, expensive Ag, which is used as the inner electrode material at the time of using the magnetic powder in the current oxide state, can be replaced by the inexpensive electrode material such as Cu, or the like, by sintering the glass powder and the metal magnetic powder under the reduction atmosphere and the vacuum condition. Therefore, the power inductor can secure the competitive price and technology.

In addition, the glass powder may be prepared by adding Fe at the time of preparing the glass. In this case, the glass itself can also be allocated with the magnetic characteristics by including the Fe component in the glass structure, thereby additionally increasing the Ms.

Although the preferred embodiments of the present invention have been disclosed for illustrative purposes, those skilled in the art will appreciate that various modifications, additions, and substitutions are possible, without departing from the scope and spirit of the invention as disclosed in the accompanying claims. Accordingly, such modifications, additions and substitutions should also be understood to fall within the scope of the present invention.

What is claimed is:

1. A multilayered power inductor including a magnetic layer having a structure in which a metal magnetic powder is distributed on a glass substrate.

2. The multilayered power inductor according to claim 1, wherein the metal magnetic powder is Fe or a Fe-alloy containing 80 wt % or more of Fe.

3. The multilayered power inductor according to claim 1, wherein the magnetic layer further includes an insulating material.

4. The multilayered power inductor according to claim 3, wherein the insulating material is glass or an organic based material.

5. The multilayered power inductor according to claim 1, wherein the metal magnetic powder is coated with glass.

6. The multilayered power inductor according to claim 1, wherein the metal magnetic powder is sequentially coated with an insulating material and glass.

7. The multilayered power inductor according to claim 1, wherein the glass substrate serves as a non-magnetic gap material for the metal magnetic powder.

8. The multilayered power inductor according to claim 1, wherein the magnetic layer is provided with an inner electrode.

9. The multilayered power inductor according to claim 8, wherein the inner electrode is one or more selected from a group consisting of Ag, Sn, Ni, Pt, Au, Cu, and an alloy thereof.

10. The multilayered power inductor according to claim 8, wherein the inner electrode is Cu.

11. A composition for a magnetic layer for a multilayered power inductor in which a metal magnetic powder is distributed on a glass substrate.

12. The composition according to claim 11, wherein the glass substrate: the metal magnetic powder is mixed at a volume ratio of 10:90 to 90:10.

13. The composition according to claim 11, wherein the glass substrate uses as main component SiO₂ of softening temperature (Ts) 500 to 800° C.

14. The composition according to claim 11, wherein the metal magnetic powder is coated with glass.

15. The composition according to claim 11, wherein the metal magnetic powder is sequentially coated with an insulating material and glass.

16. A method for preparing a multilayered power inductor, comprising:
preparing a green sheet from a mixture of a glass substrate and a metal magnetic powder;
printing and stacking an inner electrode on the green sheet; and
sintering the green sheet.

17. The method according to claim 16, wherein the sintering is performed in a reduction atmosphere or in a vacuum state.
